(19) United States
(12) Patent Application Publication
(10) Pub. No.: US 2016/0354774 A1
(43) Pub. Date: Dec. 8, 2016

(54) CENTRIFUGAL FLOW CHANNEL DEVICE AND CENTRIFUGAL FLOW CHANNEL BODY

(71) Applicant: DELTA ELECTRONICS, INC., Taoyuan City (TW)

(72) Inventors: Sheng-Yan HU, Taoyuan City (TW); Chien-Chung CHANG, Taoyuan City (TW)

(21) Appl. No.: 15/052,654

(22) Filed: Feb. 24, 2016

(30) Foreign Application Priority Data
Jun. 7, 2015 (TW) 104119507

(51) Int. Cl. B01L 3/00

(52) U.S. Cl. CPC B01L 3/502; B01L 2400/0409; B01L 2200/0647; B01L 2300/0803; B01L 2300/0861

(57) ABSTRACT

A centrifugal flow channel device is disclosed. The centrifugal flow channel device includes a channel body and a first collecting unit. The channel body includes a sample inlet, a sample channel, a first cylinder, a first reagent inlet, and a first reagent channel. The sample inlet is disposed on a surface of the channel body. The sample channel connects to the sample inlet. The first cylinder is disposed on the periphery of the sample inlet and has a first opening to allow the sample inlet to communicate with the sample channel. The first reagent inlet is disposed outside the first cylinder. The first reagent channel connects to the first reagent inlet. The first collecting unit communicates with the sample channel and the first reagent channel.

### CROSS REFERENCE TO RELATED APPLICATIONS

This Non-provisional application claims priority under 35 U.S.C. §119(a) on Patent Application No(s). 104119507 filed in Taiwan, Republic of China on Jun. 17, 2015, the entire contents of which are hereby incorporated by reference.

### BACKGROUND OF THE INVENTION

Field of Invention

The invention relates to a flow channel device and, in particular, to a centrifugal flow channel device.

Related Art

Detecting a specific biomolecule is a requirement for clinical medicine or food inspection. For example, as to clinical medicine, it can preliminarily assess whether human organs properly functions by detecting the contents of various biomolecules such as the contents of isolated cells or various proteins of blood, urine, and other body fluids, of the human body. Regarding food inspection, it may further preliminarily assess whether the food contains excess carcinogens or pesticide residues or identify genetically modified food by detecting substances in food ingredients or products. Therefore, treating the specimens and labelling the specific targets (such as biomolecules or food ingredients mentioned above) are the primary objectives for improving detection technology in various fields.

Currently, a centrifugal flow channel device can separate substances in the specimen by the centrifugal force caused by rotation, it is then mixed with the reagent, and then the specific target can be labelled. However, during the operation of the centrifugal flow channel device, only a small quantity of specimens can be injected, so it is difficult to treat a large quantity of specimens. Moreover, if the inlets of the specimen and the reagent are both disposed at the central region of the centrifugal flow channel device, the specimen and the reagent are mixed with each other and contaminated when the centrifugal flow channel device operates at a high speed.

### SUMMARY OF THE INVENTION

In view of the above subject, one objective of the invention is to provide a centrifugal flow channel device and a centrifugal flow channel body which can avoid the contamination in the inlets of the specimen and the reagent.

To achieve the above objective, a centrifugal flow channel device according to the invention includes a channel body and a first collecting unit. The channel body includes a sample inlet, a sample channel, a first cylinder, a first reagent inlet, and a first reagent channel. The sample inlet is disposed on a surface of the channel body. The sample channel connects to the sample inlet. The first cylinder is disposed on the periphery of the sample inlet and has a first opening to allow the sample inlet to communicate with the sample channel. The first reagent inlet is disposed outside the first cylinder. The first reagent channel connects to the first reagent inlet. The first collecting unit communicates with the sample channel and the first reagent channel.

To achieve the above objective, a centrifugal flow channel body according to the invention includes a sample inlet, a sample channel, a first cylinder, a first reagent inlet, a first reagent channel, and a first collecting unit. The sample channel connects to the sample inlet. The first cylinder is disposed on the periphery of the sample inlet and has a first opening to allow the sample inlet to communicate with the sample channel. The first reagent inlet is disposed outside the first cylinder. The first reagent channel connects to the first reagent inlet. The first collecting unit communicates with the sample channel and the first reagent channel.

In one embodiment, the channel body further includes a mixing channel, one end of the mixing channel connects to the sample channel and the first reagent channel, and the other end of the mixing channel communicates with the first collecting unit.

In one embodiment, the channel body further includes a second cylinder disposed on the periphery of the first reagent inlet, and the second cylinder has a second opening to allow the first reagent inlet to communicate with the first reagent channel.

In one embodiment, the sample channel has at least a branch channel, and one end of the branch channel connects to the first collecting unit.

In one embodiment, the centrifugal flow channel device further includes at least a second collecting unit, and the other end of the branch channel communicates with the second collecting unit.

In one embodiment, the channel body has at least a second reagent inlet and at least a second reagent channel, one end of the second reagent channel connects to the second reagent inlet, and the other end of the second reagent channel connects to the second collecting unit.

In one embodiment, the channel body further includes a separation tank communicating with the sample channel.

To achieve the above objective, a centrifugal flow channel device according to the invention includes a channel body, a first collecting unit, and a second collecting unit. The channel body includes a first sample inlet, a first sample channel, a first cylinder, a second sample inlet, and a second sample channel. The first sample inlet is disposed on a surface of the channel body. The first sample channel connects to the first sample inlet. The first cylinder is disposed on the periphery of the first sample inlet and has a first opening to allow the first sample inlet to communicate with the first sample channel. The second sample inlet is disposed outside the first cylinder. The second sample channel connects to the second sample inlet. The first collecting unit communicates with the other end of the first sample channel. The second collecting unit communicates with the other end of the second sample channel.

In one embodiment, the channel body further includes a second cylinder disposed on the periphery of the second sample inlet, and the second cylinder has a second opening to allow the second sample inlet to communicate with the second sample channel.

In one embodiment, the channel body further includes at least a third sample inlet and at least a third sample channel, the third sample inlet is disposed outside the second cylinder, and the third sample channel connects to the third sample inlet.

In one embodiment, the centrifugal flow channel device further includes at least a third collecting unit communicating with the other end of the third sample channel.

In one embodiment, the first collecting unit or the second collecting unit is detachably disposed on the channel body.

In one embodiment, the first collecting unit or the second collecting unit is disposed on the outer periphery of the channel body.

In one embodiment, the first collecting unit or the second collecting unit has a liquid accommodating space, and the first collecting unit or the second collecting unit protrudes from another surface of the channel body.

As mentioned above, the centrifugal flow channel device and the centrifugal flow channel body according to the invention can collect separated specimens once which are treated or not treated by the reagent through the channel especially multiple channels. Moreover, the device can be designed with the multiple channels and multiple cylinders to accomplish a variety of reagent tests once and prevent the contamination caused by the mix of reagents from each inlet simultaneously. Further, a variety of independent detection tests can be accomplished on the centrifugal micro-channel device benefiting from multiple cylinders and multiple channels.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a centrifugal flow channel device according to the first embodiment of the invention;

FIG. 2 is a schematic diagram of channels of the centrifugal flow channel device shown in FIG. 1;

FIG. 3 is a top view of a centrifugal flow channel device according to the second embodiment of the invention;

FIG. 4 is a schematic diagram of a centrifugal flow channel device according to the third embodiment of the invention;

FIG. 5 is a top view of a centrifugal flow channel device according to the fourth embodiment of the invention;

FIGS. 6A and 6B are top views of a centrifugal flow channel device according to the fifth embodiment of the invention;

FIG. 7A is a schematic diagram of a centrifugal flow channel device according to the sixth embodiment of the invention;

FIG. 7B is a lateral view of another embodiment of the collecting unit shown in FIG. 7A;

FIG. 7C is a lateral view of another embodiment of the collecting unit shown in FIG. 7B;

FIG. 8A is a schematic diagram of a centrifugal flow channel device according to the seventh embodiment of the invention; and

FIG. 8B is a lateral view of the centrifugal flow channel device shown in FIG. 8A.

### DETAILED DESCRIPTION OF THE INVENTION

The present invention will be apparent from the following detailed description, which proceeds with reference to the accompanying drawings, wherein the same references relate to the same elements.

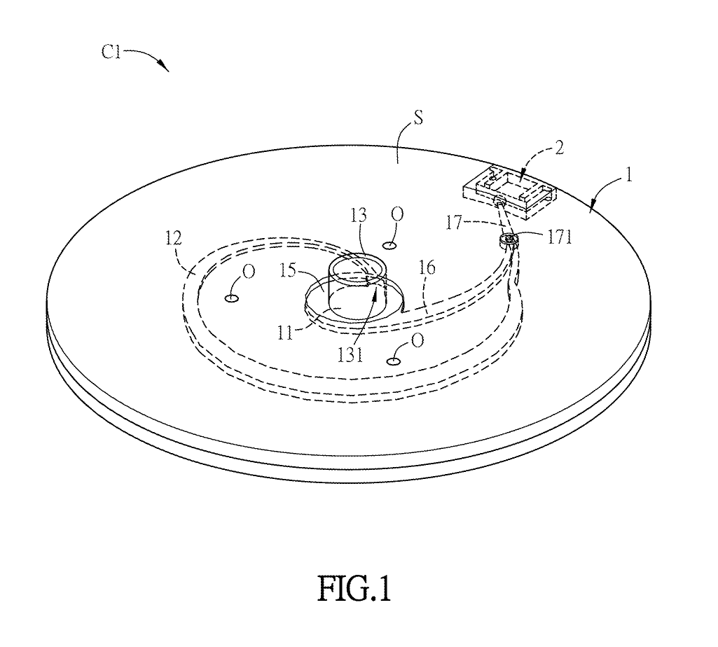

Referring to FIG. 1, it is a schematic diagram of a centrifugal flow channel device according to the first embodiment of the invention. The centrifugal flow channel device C1 of the embodiment may be applied to different kinds of specimens which are fluids. They may be, for example but not limited to, blood specimens, plasma fluids, urine, fluid-like food ingredients, or other fluid-like biological specimens. Moreover, the centrifugal flow channel device C1 of the embodiment can be further applied to the specimen which has detecting targets (specific biomolecules or substances) at lower concentration. That is to say, less content of detecting targets exists in the specimen. Therefore, it is necessary to inject a large quantity of specimens to obtain a sufficient quantity of detecting targets. The centrifugal flow channel device C1 of the embodiment may also be applied to treating a large quantity of specimens.

The centrifugal flow channel device C1 includes a channel body 1 and a first collecting unit 2. In the embodiment, the channel body 1 includes a sample inlet 11, a sample channel 12, a first cylinder 13, a first reagent inlet 15, a first reagent channel 16, and a mixing channel 17. The channel body 1 of the embodiment is disc-shaped. The disc-shape is thick enough to have the sample channel 12, the first reagent channel 16, and the mixing channel 17 formed inside the channel body 1, and the sample inlet 11, the first cylinder 13, and the first reagent inlet 15 are located on the surface S of the channel body 1. The material of the channel body 1 may be plastic material, metal, glass, or other materials. Here, the plastic material may be, for example, polymethylmethacrylate (PMMA) or other thermoplastics.

In detail, the sample inlet 11 may be downwardly recessed from the surface S so as to form a concave structure. The sample channel 12 is formed inside the channel body 1 and connects to the sample inlet 11. The first cylinder 13 is disposed on the periphery of the sample inlet 11. In general, the first cylinder 13 is extended from the periphery of the sample inlet 11 to form a side wall, and the side wall surrounds the sample inlet 11 to form the first cylinder 13 which protrudes from the surface S. Here, the first cylinder 13 has a first opening 131 located at the joint between the sample inlet 11 and the sample channel 12 so as to allow the sample inlet 11 to communicate with the sample channel 12. After injected from the sample inlet 11, the specimen flows into the sample channel 12 through the first opening 131.

Moreover, in the embodiment, the sample inlet 11 and the first cylinder 13 are located in the geometric center of the channel body 1, so they contribute to that the liquid sample can be constantly injected during the operation of the centrifugal flow channel device C1. It should be noted that the geometric center of the embodiment is not a center point but a region adjacent to the geometric center. In detail, the centrifugal flow channel device C1 of the embodiment may be utilized with a rotational platform. The rotational platform drives the centrifugal flow channel device C1 to rotate and generate the required centrifugal force to separate the contents of the specimen. The centrifugal flow channel device C1 further has a through positioning hole O. In the embodiment, the centrifugal flow channel device C1 has three positioning holes O located on the channel body 1. The centrifugal flow channel device C1 may be fixed to the rotational platform through the positioning hole O so the centrifugal flow channel device C1 can be driven by the rotational platform to rotate. For simplicity of drawings, the positioning hole O is not specifically drawn in the following drawings. Because the position of the geometric center of the channel body 1 is unchanged and does not deviate by the rotation, the specimen can be constantly injected into the sample inlet 11. Then, it can be applied to the experiments or detection methods which need to separate a large quantity of specimens. The configuration of the channel body 1 is not limited in the invention, but it needs to steadily rotate to generate the centrifugal force. Preferably, the channel body 1 may be like a circular disc.

Similarly, the first reagent inlet 15 is disposed on the surface S, and the first reagent inlet 15 is disposed outside the first cylinder 13. Here, the first reagent inlet 15 may be a concave structure, and the first reagent channel 16 is similarly inside the channel body 1 and connects to the first reagent inlet 15. In the embodiment, the sample inlet 11 and the first reagent inlet 15 have the same shape but different sizes. Namely, the diameter of the first reagent inlet 15 is greater than that of the sample inlet 11 so the sample inlet 11 and the first reagent inlet 15 can be disposed in the geometric center of the channel body 1 simultaneously. Accordingly, the sample inlet 11 and the first cylinder 13 located inside are concentric with the first reagent inlet 15 located outside. Therefore, the specimen and the reagent can be constantly injected.

During the operation of the centrifugal flow channel device C1, the specimen may be injected into the sample inlet 11 and the reagent may be injected into the first reagent inlet 15, so that the sample channel 12 and the first reagent channel 16 are respectively loaded with the specimen and the reagent by the centrifugal force. Moreover, the first cylinder 13 can prevent the sample from being mixed with the reagent before the sample is separated. If designed with multiple channels, the device may be further designed with multiple cylinders to accomplish a variety of reagent tests once and prevent the contamination caused by the mix of reagents from each inlet (the sample inlet and multiple reagent inlets) simultaneously. The details are described below.

In the embodiment, one end of the sample channel 12 connects to the sample inlet 11 disposed in the geometric center of the channel body 1, and the other end of the sample channel 12 is extended outward along a spiral or an arc path to form an arc structure which surrounds the sample inlet 11 and is disposed inside the channel body 1.

Similarly, the first reagent channel 16 may be like an arc structure surrounding the first reagent inlet 15, and the extremity of the first reagent channel 16 communicates with the mixing channel 17. In the embodiment, one end of the mixing channel 17 further has a junction 171 to connect to the sample channel 12 and the first reagent channel 16, so the specimen and the reagent can converge at the junction 171 and then enter the mixing channel 17. The other end of the mixing channel 17 communicates with the first collecting unit 2, so the mixed solution of the specimen and the reagent may flow into the first collecting unit 2. Similarly, the details are described below.

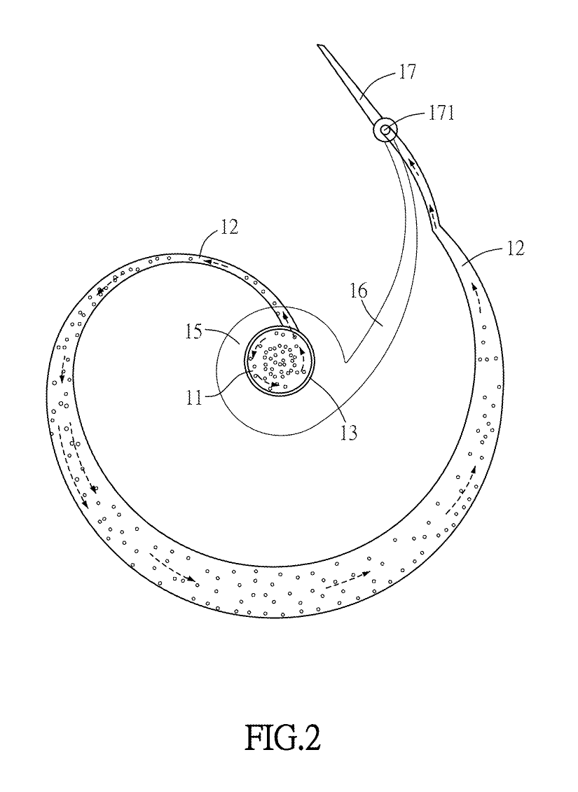

Referring to FIGS. 1 and 2, FIG. 2 is a schematic diagram of channels of the centrifugal flow channel device shown in FIG. 1. When the channel body 1 is driven to rotate, the centrifugal force can drive the specimen to flow from the sample inlet 11 toward the outside of the channel body 1 (the flow direction is indicated by arrows). It can similarly drive the reagent to flow from the first reagent inlet 15 toward the outside of the channel body 1 and to flow respectively along the spiral (or arc-shaped) sample channel 12 and first reagent channel 16.

In the sample channel 12, because the specimen is affected by the centrifugal force, small molecules driven by the centrifugal force suspend and flow into the mixing channel 17. Moreover, in the first reagent channel 16, after being injected into the first reagent inlet 15, the reagent is driven by the centrifugal force to directly flow through the first reagent channel 16 and then enter the mixing channel 17 where the reagent can be mixed with the specimen. Here, the reagent may be a buffer solution or a reagent which can be used to label biomolecules. For example, the reagent may have a material which can label circulating tumor cells (i.e. detecting targets), and the material may be, for example but not limited to, a fluorescent dye, an antibody, an immuno-marker, a magnetic bead, or the likes. Therefore, the detecting targets (i.e. biomolecules or substances to be detected) may enter the first collecting unit 2 after being labelled in the mixing channel 17. Besides, the detecting targets may also be labelled in the first collecting unit 2. Thereby, the content of the detecting targets in the specimen is detected. For example, the content of a specific biomolecule (e.g. circulating tumor cell) in a blood specimen or a specific ingredient (e.g. pesticide residue) in a food ingredient can be detected. In the embodiment, the first collecting unit 2 is disposed on the outer periphery of the channel body 1 which is like a circular disc, the first collecting unit 2 may be directly formed inside the channel body 1 or detachably disposed on the channel body 1, and it is not limited thereto.

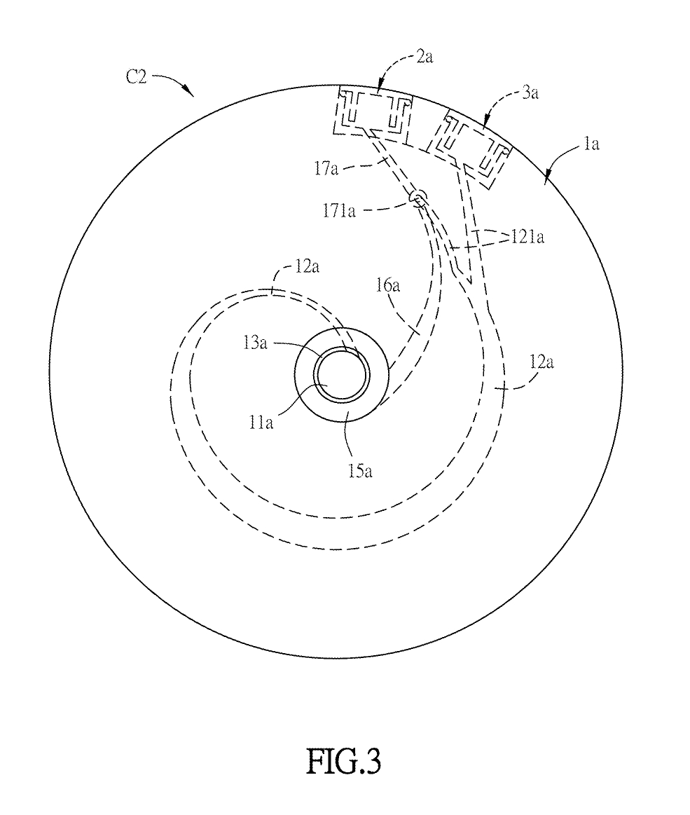

FIG. 3 is a top view of a centrifugal flow channel device according to the second embodiment of the invention. As shown in FIG. 3, in the embodiment, the centrifugal flow channel device C2 can also have a branch channel and a plurality of collecting units to collect a specimen which is not treated by the reagent simultaneously. In the embodiment, the sample channel 12a of the channel body 1a has branch channels 121a, and one end of the branch channel 121a connects to the mixing channel 17a. Following the flow direction of the sample channel 12a, the branch channel 121a is disposed at the posterior end of the sample channel 12a. The centrifugal flow channel device C2 has two collecting units namely the first collecting unit 2a and the second collecting unit 3a of which structures are substantially the same or similar. The first collecting unit 2a connects to the mixing channel 17a to receive the specimen which is mixed with the reagent, and the second collecting unit 3a communicates with the branch channel 121a to merely receive the specimen. Therefore, after a user operates the centrifugal flow channel device C2 of the embodiment once, the specimens which are treated or not treated by the reagent can be directly observed. Because the detailed features of other elements of the centrifugal flow channel device C2 may directly refer to the centrifugal flow channel device C1 of the first embodiment, they are not repeated here.

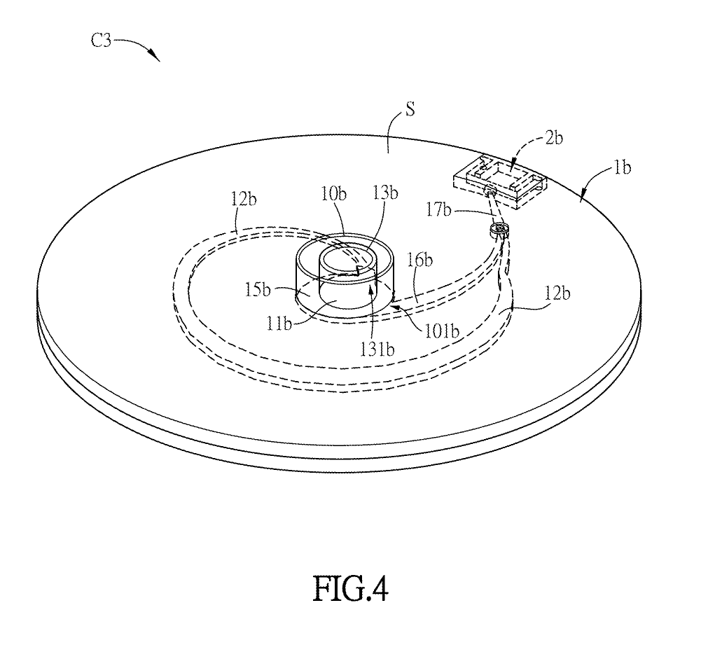

FIG. 4 is a schematic diagram of a centrifugal flow channel device according to the third embodiment of the invention. As shown in FIG. 4, the channel body 1b of the centrifugal flow channel device C3 according to the embodiment may further have a plurality of second cylinders 10b. The structure of the second cylinder 10b may refer to the first cylinder 13b and the connection between the first opening 131b of the first cylinder 13b and the sample inlet 11b. Here, the second cylinder 10b is disposed on the periphery of the first reagent inlet 15b, and the second cylinder 10b has a second opening 101b to allow the first reagent inlet 15b to communicate with and the first reagent channel 16b. Moreover, the structure of double cylinders (the first cylinder 13b and the second cylinder 10b) can more effectively prevent the specimen from contacting the reagent beforehand. Because the connection between the sample channel 12b, the mixing channel 17b, and the first collecting unit 2b may refer to the first embodiment, it is not repeated here.

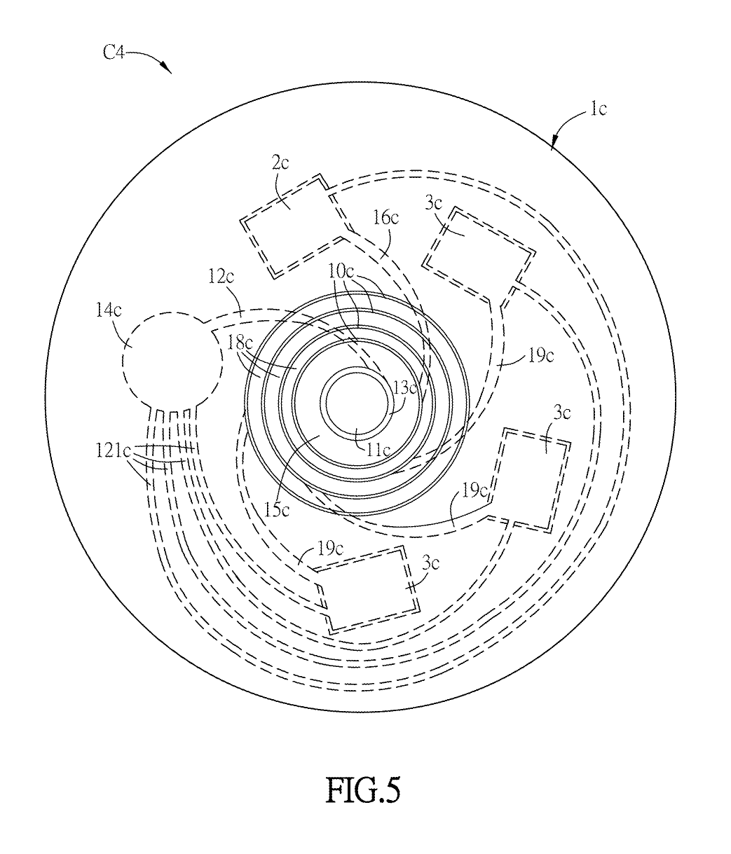

Referring to FIG. 5, it is a top view of a centrifugal flow channel device according to the fourth embodiment of the invention. In the embodiment, the centrifugal flow channel device C4 is designed with the multiple reagent inlets, the corresponding cylinders, the branch channels and the corresponding collecting units according to the second embodiment, so it may collect the specimens treated by different reagents for one time only. In detail, the channel body 1c of the embodiment has a plurality of reagent inlets namely a first reagent inlet 15c and a plurality of second reagent inlets 18c and correspondingly has a first reagent channel 16c and a plurality of second reagent channels 19c. The second reagent inlet 18c and the first reagent inlet 15c are generally the same in structures, but their diameters are different. Moreover, the diameters of the second reagent inlets 18c are all different, and they are concentric with each other. Taking one of the second reagent inlet 18c for example, preferably, the diameter of the second reagent inlet 18c is greater than that of the first reagent inlet 15c, and the second reagent inlet 18c is disposed outside and concentric with the first reagent inlet 15c. The structure of the second reagent channel 19c and that of the first reagent channel 16c are substantially the same, and one end of the second reagent channel 19c connects to the second reagent inlet 18c. Thus, the reagent can flow from the second reagent inlet 18c into the second reagent channel 19c.

Preferably, the channel body 1c of the embodiment further has a plurality of second cylinders 10c, and the structure of the second cylinder 10c may refer to the first cylinder 13c and the second cylinder 10b of the third embodiment. The second cylinders 10c are respectively disposed on the peripheries of the first reagent inlet 15c and the second reagent inlet 18c so the cylinders (including the first cylinder 13c and a plurality of second cylinders 10c) are disposed on the peripheries of the sample inlet 11c, the first reagent inlet 15c, and the second reagent inlet 18c. Thus, the cross contamination between the reagents and the prior contact between the specimen and the reagent can be avoided.

In the embodiment, the centrifugal flow channel device C4 also has a plurality of second collecting units 3c which with the first collecting unit 2c are all located on the channel body 1c. The branch channel 121c of the sample channel 12c communicates with the first collecting unit 2c or the second collecting unit 3c. One end of the second reagent channel 19c connects to the second reagent inlet 18c, and the other end connects to the second collecting unit 3c. The reagent injected from the second reagent inlet 18c may be mixed with the specimen in the second collecting unit 3c to label the detecting target or perform the reaction. In the embodiment, different reagents can be injected into the first reagent inlet 15c and different second reagent inlets 18c to perform different detection tests, so a variety of detection tests can be accomplished once. Furthermore, the cross contamination between the reagents can be avoided by multiple cylinders (the first cylinder 13c and the multiple second cylinders 10c). As to the conventional centrifugal flow channel devices, they are all disposable laboratory supplies. However, the centrifugal flow channel device C4 of the embodiment is designed with multiple cylinders (the first cylinder 13c and multiple second cylinders 10c) and multiple channels (the branch channel 121c, the first reagent channel 16c, and the second reagent channel 19c), so a variety of detection tests can be accomplished once to save supplies.

Preferably, the channel body 1c of the embodiment further includes a separation tank 14c which communicates with the sample channel 12c. In detail, the separation tank 14c of the embodiment is adjacent to the sample channel 12c, and the sample channel 12c and one end of the separation tank 14c communicate with each other. The other end of the separation tank 14c branches to form a plurality of branch channels 121c. Four branch channels 121c are illustrated for example in the embodiment, and the branch channel 121c directly connects to the first collecting unit 2c or the second collecting unit 3c. Here, the separation tank 14c of the embodiment may be used for accommodating a density gradient solution. While the channel body 1c is driven to rotate, the density gradient solution can form the density gradient in the separation tank 14c, and the cells of different weights in the specimen can be screened due to the density gradient. In detail, the density gradient solution is affected by the centrifugal force to form the density gradient in the separation tank 14c, the density is lower near the inner edge of the channel body 1c and higher near the outer edge of the channel body 1c. Generally, the specimen includes heavier macromolecules and lighter small molecules. The lighter molecules is screened out by the separation tank 14c with the density gradient, and it flows toward the branch channel 121c due to the centrifugal force and then flows into the first collecting unit 2c or the second collecting unit 3c. However, the macromolecules are washed and subside in the separation tank 14c.

Briefly, the flow path of the specimen starts from the sample inlet 11c. The specimen flows along the sample channel 12c, the small molecules in the specimen pass through the separation tank 14c and the branch channel 121c due to the centrifugal force and then flow toward the mixing channel 17c. Moreover, the macromolecules are affected by the centrifugal force and screened out by the density gradient and then stay in the separation tank 14c. Therefore, the small molecules and the macromolecules can be separated, so that the specimen which enters the mixing channel 17c only has the small molecules (for example, circulating tumor cells in a blood specimen). After flowing through the branch channel 121c, the separated specimen enters the first collecting unit 2c or the second collecting unit 3c so as to separate and collect the small molecules of the specimen. In the embodiment, the first reagent channel 16c and the second reagent channel 19c also directly connect to the first collecting unit 2c or the second collecting unit 3c. Therefore, after being injected from the first reagent inlet 15c and the second reagent inlet 18c, a variety of different reagents can flow toward the first collecting unit 2c or the second collecting unit 3c respectively by the centrifugal force to mix with the separated specimen in the first collecting unit 2c or the second collecting unit 3c, thus labelling the detecting target.

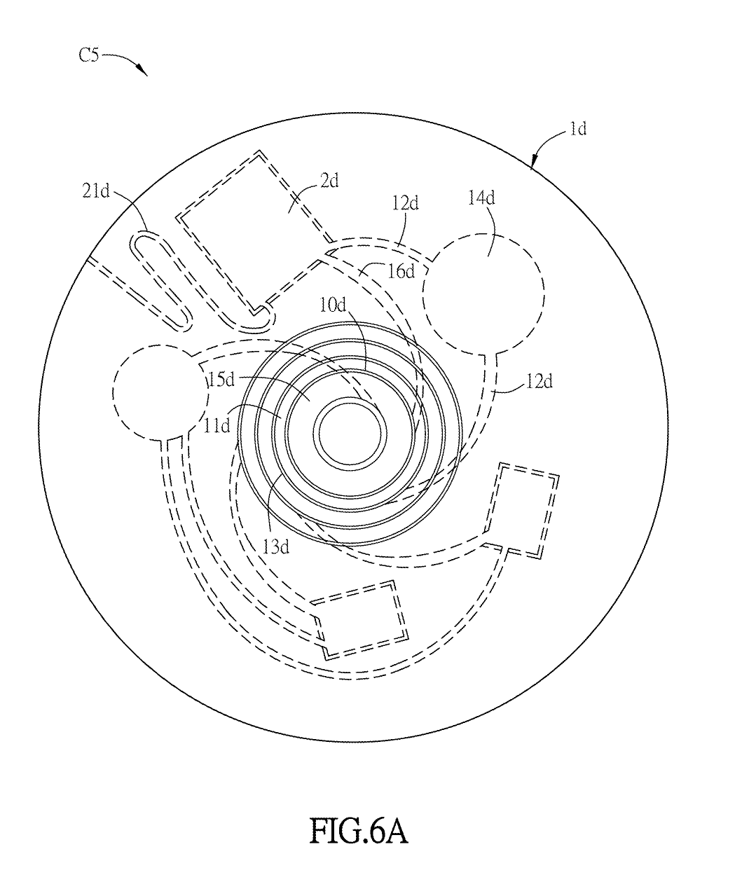

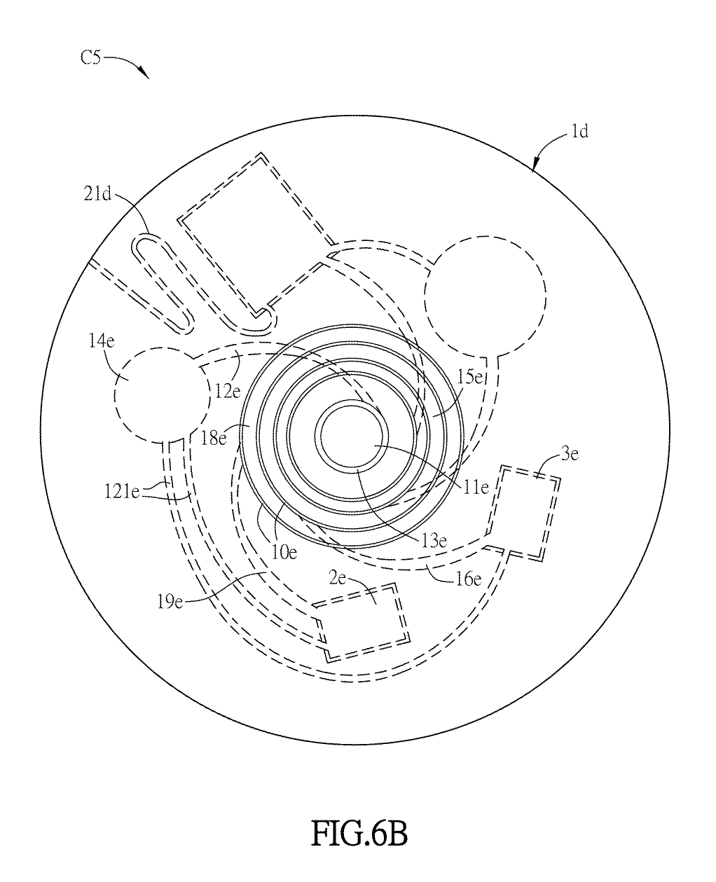

FIGS. 6A and 6B are top views of a centrifugal flow channel device according to the fifth embodiment of the invention. Referring to FIG. 6A, as to the centrifugal flow channel device C5 of the embodiment, benefiting from multiple cylinders and multiple branch channels, two or more independent detection tests can be performed on one centrifugal flow channel device C5. The centrifugal flow channel device C5 which can perform two independent detection tests is illustrated for example in the following description. The centrifugal flow channel device C5 of the embodiment includes the channel body 1d, the first collecting units 2d and 2e, and the second collecting unit 3e. For simplicity of drawings, the channels and the collecting unit for one independent detection test is labelled in FIG. 6A, and those for another independent detection test is labelled in FIG. 6B. As shown in FIG. 6A, the sample inlet 11d, the sample channel 12d, the first cylinder 13d, the second cylinder 10d, the separation tank 14d, the first reagent inlet 15d, the first reagent channel 16d, and the first collecting unit 2d together form the channels and the collecting unit which are used for one independent detection test. As shown in FIG. 6B, the sample inlet 11e, the sample channel 12e, the branch channel 121e, the first cylinder 13e, the second cylinder 10e, the first reagent inlet 15e, the first reagent channel 16e, the second reagent inlet 18e, the second reagent channel 19e, the first collecting unit 2e, and the second collecting unit 3e together form the channels and the collecting units which are used for another independent detection test. The configuration of the sample inlets 11d and 11e, the first reagent inlets 15d and 15e, and the second reagent inlet 18e is not limited, and the details of other connections are not repeated here since they may refer to the embodiments described above. In addition, as shown in FIG. 6A, the collecting unit 2d can be designed with more accommodating space to accommodate more specimens, and the excess specimens can be discharged by the overflow channel 21d. Therefore, the centrifugal flow channel device C5 of the embodiment can also collect the specimens of different volumes once which are treated by different reagents.

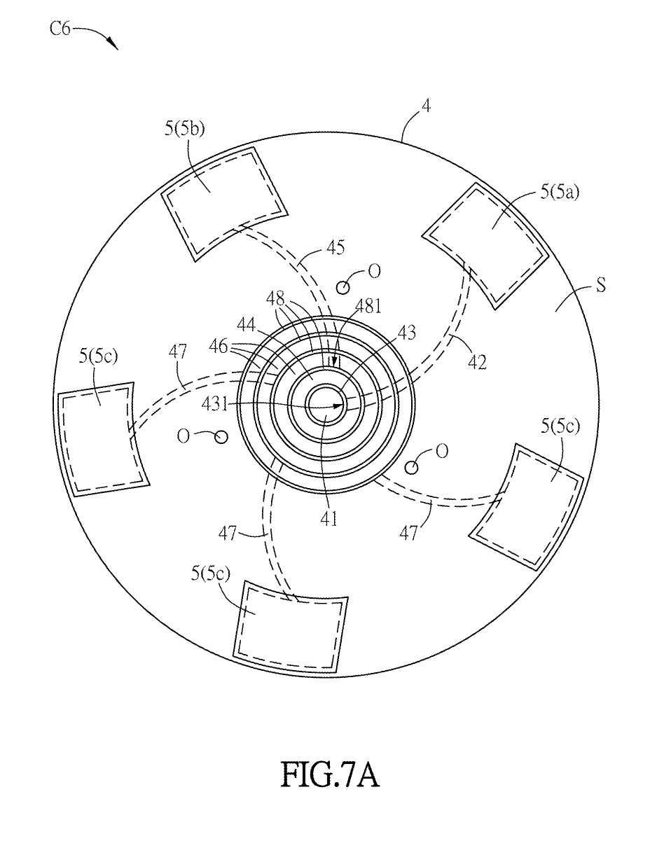

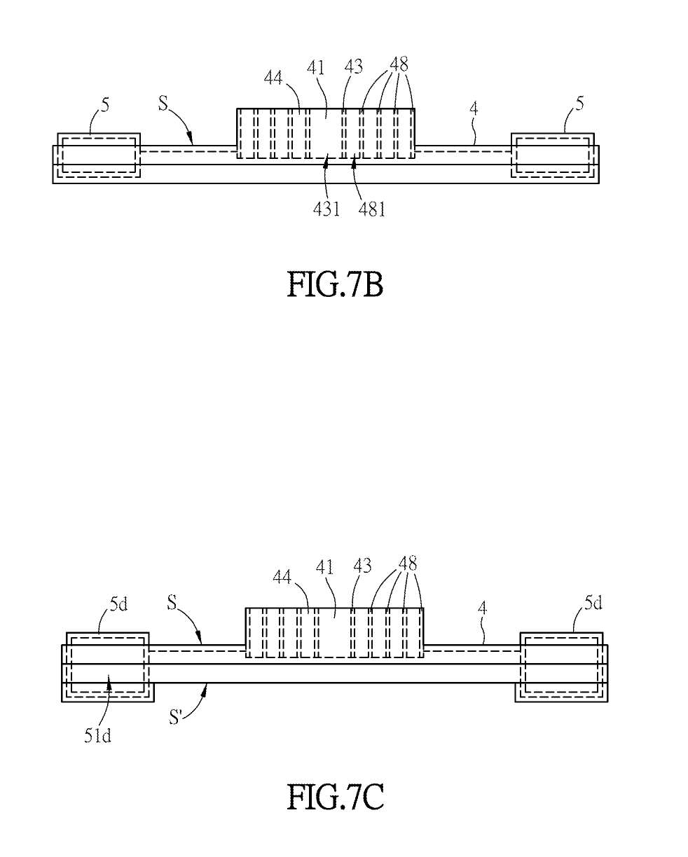

FIG. 7A is a schematic diagram of a centrifugal flow channel device according to the sixth embodiment of the invention. Referring to FIG. 7A, the centrifugal flow channel device C6 of the embodiment may be used for merely collecting the specimen. In detail, the centrifugal flow channel device C6 includes a channel body 4 and a plurality of collecting units 5 (a first collecting unit 5a, a second collecting unit 5b, and a plurality of third collecting units 5c), and the collecting units 5 of the embodiment are disposed on the outer periphery of the channel body 4. Here, the channel body 4 includes a first sample inlet 41, a first sample channel 42, a first cylinder 43, a second sample inlet 44, and a second sample channel 45. It is the same as the sample inlets and the reagent inlets of the embodiments mentioned above. In the embodiment, the first sample inlet 41 and the second sample inlet 44 both are disposed on a surface S of the channel body 4. The first sample channel 42 connects to the first sample inlet 41. The first cylinder 43 is disposed on the periphery of the first sample inlet 41, and the first cylinder 43 has a first opening 431 to allow the first sample inlet 41 to communicate with the first sample channel 42. The second sample inlet 44 is disposed outside the first cylinder 43. The second sample channel 45 connects to the second sample inlet 44. Because the details of the structures of the first sample inlet 41 and the second sample inlet 44 may refer to the sample inlets and the reagent inlets of the embodiments mentioned above, and the details of the structures of the first sample channel 42 and the second sample channel 45 may refer to the sample channels and the reagent channels of the embodiments mentioned above, they are not repeated here.

The centrifugal flow channel device C6 of the embodiment has a plurality of collecting units 5. First, the first collecting unit 5a and the second collecting unit 5b are illustrated for example. The first collecting unit 5a communicates with the other end of the first sample channel 42. That is to say, one end of the first sample channel 42 connects to the first sample inlet 41, and the other end of the first sample channel 42 communicates with the first collecting unit 5a. Similarly, one end of the second sample channel 45 connects to the second sample inlet 44, and the other end of the second sample channel 45 communicates with the second collecting unit 5b. The centrifugal flow channel device C6 of the embodiment further includes three third collecting units 5c. Correspondingly, the channel body 4 includes three third sample inlets 46 and three third sample channels 47, so that the third collecting unit 5c can communicate with one end of the third sample channel 47.

Preferably, the channel body 4 further includes a plurality of second cylinders 48 which are disposed on the peripheries of the second sample inlet 44 and the third sample inlet 46. Therefore, different specimens can be injected into the first sample inlet 41, the second sample inlet 44, and the third sample inlet 46, and they will not be cross contaminated benefiting from the first cylinder 43 and the second cylinder 48. Similarly, the second cylinder 48 has a second opening 481 to allow the second sample inlet 44 to communicate with the second sample channel 45.

FIG. 7B is a lateral view of another embodiment of the collecting unit shown in FIG. 7A. Referring to FIGS. 7A and 7B, the collecting unit 5 (the first collecting unit 5a, the second collecting unit 5b, or the third collecting unit 5c) may be fixedly disposed on the channel body 4, it may also detachably disposed on the channel body 4 as shown in FIG. 7A, and it may be placed from the top of the channel body 4 as shown in FIG. 7B. Referring to FIG. 7C, it is a lateral view of another embodiment of the collecting unit shown in FIG. 7B. In the embodiment, the collecting unit 5d (the first collecting unit, the second collecting unit, and/or the third collecting unit) has a liquid accommodating space 51d. Disposed on the channel body 4, the collecting unit 5d is extended from another surface S′ of the channel body 4 and protrude to accommodate more specimens.

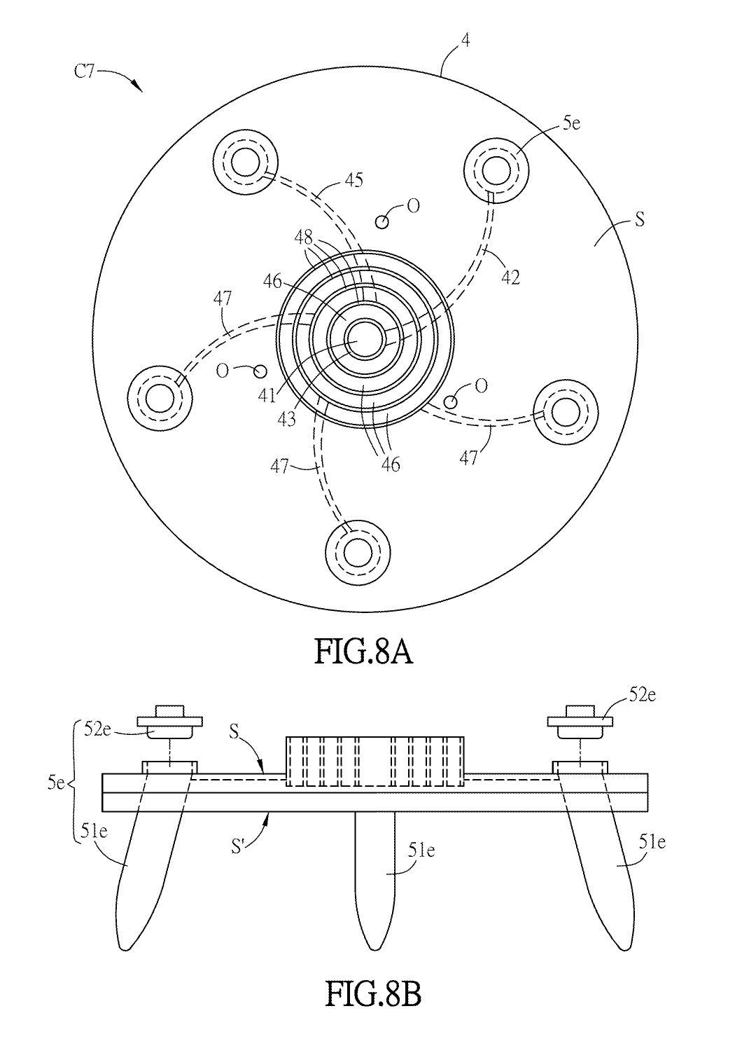

Referring to FIGS. 8A and 8B, FIG. 8A is a schematic diagram of a centrifugal flow channel device according to the seventh embodiment of the invention, and FIG. 8B is a lateral view of the centrifugal flow channel device shown in FIG. 8A. Similarly, in the embodiment, the collecting unit 5e of the centrifugal flow channel device C7 (the first collecting unit, the second collecting unit, and/or the third collecting unit) also has a liquid accommodating space 51e, and the collecting unit 5e is detachably disposed on the channel body 4. Here, the channel body 4 may have a plurality of hollow structures for the collecting unit 5e to be inserted into. Disposed on the channel body 4, the bottom of the collecting unit 5e is extended and protrudes from another surface S′ of the channel body 4. Namely, it protrudes from the surface S′ which does not have the sample inlets (the first sample inlet 41, the second sample inlet 44, and the third sample inlet 46). Moreover, the top of the collecting unit 5e can be sealed by the lid 52e to prevent the collected specimen from spilling out. Here, the top of the collecting unit 5e and the lid 52e may have corresponding threads to fix the lid 52e by screwing. Furthermore, the lid 52e may also be an elastic rubber material, and the size of the lid 52e is slightly larger than that of the top of the collecting unit 5e so as to seal the collecting unit 5e by the lid 52e of elastic material. Certainly, the lid 52e of rubber material may also have the structure of threads. Because the details of the features of the channel body may refer to the embodiments mentioned above, they are not repeated here.

Additionally, a centrifugal flow channel body is further provided which includes a sample inlet, a sample channel, a first cylinder, a first reagent inlet, a first reagent channel, and a first collecting unit. The sample channel is connects to the sample inlet. The first cylinder is disposed on the periphery of the sample inlet, and the first cylinder has a first opening to allow the sample inlet to communicate with the sample channel. The first reagent inlet is disposed outside the first cylinder, and the first reagent channel connects to the first reagent inlet. The first collecting unit communicates with the sample channel and the first reagent channel. Because the structures of the elements of the centrifugal flow channel body and the connection between the elements may refer to the above description, they are not repeated here.

In summary, the centrifugal flow channel device and the centrifugal flow channel body according to the invention can collect separated specimens once which are treated or not treated by the reagent through the channel especially multiple channels. Moreover, the device can be designed with the multiple channels and multiple cylinders to accomplish a variety of reagent tests once and prevent the contamination caused by the mix of reagents from each inlet simultaneously. Further, a variety of independent detection tests can be accomplished on the centrifugal micro-channel device benefiting from multiple cylinders and multiple channels.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A centrifugal flow channel device, comprising:
a channel body, comprising:
a sample inlet, disposed on a surface of the channel body;
a sample channel, connecting to the sample inlet;
a first cylinder, disposed on the periphery of the sample inlet, wherein the first cylinder has a first opening to allow the sample inlet to communicate with the sample channel;
a first reagent inlet, disposed outside the first cylinder; and
a first reagent channel, connecting to the first reagent inlet; and
a first collecting unit, communicating with the sample channel and the first reagent channel.

2. The centrifugal flow channel device of claim 1, wherein the channel body further comprises a mixing channel, one end of the mixing channel connects to the sample channel and the first reagent channel, and the other end of the mixing channel communicates with the first collecting unit.

3. The centrifugal flow channel device of claim 1, wherein the channel body further comprises a second cylinder disposed on the periphery of the first reagent inlet, and the second cylinder has a second opening to allow the first reagent inlet to communicate with the first reagent channel.

4. The centrifugal flow channel device of claim 1, wherein the sample channel has at least a branch channel, and one end of the branch channel connects to the first collecting unit.

5. The centrifugal flow channel device of claim 4, further comprising:
at least a second collecting unit, wherein another end of the branch channel communicates with the second collecting unit.

6. The centrifugal flow channel device of claim 5, wherein the channel body has at least a second reagent inlet and at least a second reagent channel, one end of the second reagent channel connects to the second reagent inlet, and the other end of the second reagent channel connects to the second collecting unit.

7. The centrifugal flow channel device of claim 1, wherein the channel body further comprises a separation tank communicating with the sample channel.

8. A centrifugal flow channel device, comprising:
a channel body, comprising:
a first sample inlet, disposed on a surface of the channel body;
a first sample channel, connecting to the first sample inlet;
a first cylinder, disposed on the periphery of the first sample inlet, wherein the first cylinder has a first opening to allow the first sample inlet to communicate with the first sample channel;
a second sample inlet, disposed outside the first cylinder; and
a second sample channel, connecting to the second sample inlet;
a first collecting unit, communicating with the other end of the first sample channel; and
a second collecting unit, communicating with the other end of the second sample channel.

9. The centrifugal flow channel device of claim 8, wherein the channel body further comprises a second cylinder disposed on the periphery of the second sample inlet, and the second cylinder has a second opening to allow the second sample inlet to communicate with the second sample channel.

10. The centrifugal flow channel device of claim 9, wherein the channel body further comprises at least a third sample inlet and at least a third sample channel, the third sample inlet is disposed outside the second cylinder, and the third sample channel connects to the third sample inlet.

11. The centrifugal flow channel device of claim 10, further comprising:
at least a third collecting unit, communicating with the other end of the third sample channel.

12. The centrifugal flow channel device of claim 8, wherein the first collecting unit or the second collecting unit is detachably disposed on the channel body.

13. The centrifugal flow channel device of claim 8, wherein the first collecting unit or the second collecting unit is disposed on the outer periphery of the channel body.

14. The centrifugal flow channel device of claim 8, wherein the first collecting unit or the second collecting unit has a liquid accommodating space, and the first collecting unit or the second collecting unit protrudes from another surface of the channel body.

15. A centrifugal flow channel body, comprising:
a sample inlet;
a sample channel, connecting to the sample inlet;
a first cylinder, disposed on the periphery of the sample inlet, wherein the first cylinder has a first opening to allow the sample inlet to communicate with the sample channel;
a first reagent inlet, disposed outside the first cylinder;
a first reagent channel, connecting to the first reagent inlet; and
a first collecting unit, communicating with the sample channel and the first reagent channel.

16. The channel body of claim 15, further comprising:
a mixing channel, wherein one end of the mixing channel connects to the sample channel and the first reagent channel, and the other end of the mixing channel communicates with the first collecting unit.

17. The channel body of claim 15, further comprising:
a second cylinder, disposed on the periphery of the first reagent inlet, wherein the second cylinder has a second opening to allow the first reagent inlet to communicate with the first reagent channel.

18. The channel body of claim 15, wherein the sample channel has at least a branch channel, and one end of the branch channel connects to the first collecting unit.

19. The channel body of claim 18, further comprising:
at least a second collecting unit, wherein the other end of the branch channel communicates with the second collecting unit.

20. The channel body of claim 19, wherein the channel body has at least a second reagent inlet and at least a second reagent channel, one end of the second reagent channel connects to the second reagent inlet, and the other end of the second reagent channel connects to the second collecting unit.
